(19) United States
(12) Patent Application Publication
(10) Pub. No.: US 2019/0055798 A1
(43) Pub. Date: Feb. 21, 2019

(54) INTEGRATED, AUTOMATED POSSUM BELLY

(71) Applicant: Schlumberger Technology Corporation, Sugar Land, TX (US)

(72) Inventors: Babak Bob Arefi, Spring, TX (US); Franz Aguirre, Sugar Land, TX (US); Christopher Shane Lalumandier, Sugar Land, TX (US)

(21) Appl. No.: 15/680,318

(22) Filed: Aug. 18, 2017

(51) Int. Cl. E21B 21/06; B01D 33/27; B01D 35/02; B01D 33/80

(52) U.S. Cl. CPC E21B 21/065; B01D 33/27; B01D 2201/184; B01D 33/804; B01D 2201/02; B01D 35/02

(57) ABSTRACT

An integrated possum belly having a raised filter portion and collection troughs is disclosed. A fluid flow such as a drilling fluid can contain unwanted material such as gumbo which can clog pipes and other equipment. The fluid flow is deposited onto the raised filter portion that has sloped sides with openings in the sloped sides. The fluid passes through the openings and is collected, while the gumbo and other debris remains on the filter and is collected and discarded. Sensors and a controller can be used to automate aspects of the operation of the possum belly including the opening of the filter.

### BACKGROUND

Oil and gas drilling operations use drilling fluid or drilling mud to lubricate, cool, and circulate fluid in the well. A regular occurrence is the formation of gumbo, which is a generic term for soft, sticky, swelling clay formations that are frequently encountered in surface holes offshore or in sedimentary basins onshore near seas. Gumbo fouls drilling tools and plugs piping. Possum bellies are tools used to separate gumbo from drilling mud; however, conventional designs are inefficient and are themselves prone to clogging, sometimes requiring an operator to manually clear gumbo from the possum belly.

### SUMMARY

Embodiments of the present disclosure are directed to a possum belly that can be used to separate unwanted material from a fluid flow. The possum belly can include a filter having a plurality of slats forming an apex and sloped sides. The slats form a first layer. The possum belly also includes a second layer movable relative to the first layer from a first position to a second position. In the first position the slats are aligned with openings in the second layer and the filter is closed. In the second position the openings in the second layer are positioned at least partially between the slats and the filter is at least partially open. The possum belly also includes a trough positioned relative to the filter to receive material deposited onto the filter from above that does not pass through the filter, and a lower collection area below the filter and being configured to receive material deposited onto the filter from above that passes through the filter. The slats can form a cone-shaped filter and wherein the second layer is rotatable relative to the first layer. The slats form a pyramid and wherein the second layer moves linearly relative to the first layer.

Other embodiments of the present disclosure are directed to an integrated possum belly including a filter unit having sloped sides, an apex, and a plurality of closable openings. The filter is configured to receive a fluid deposited onto the apex from above. The integrated possum belly also includes a first receiving chamber configured to receive material that does not fit through the closable openings, and a second receiving chamber configured to receive material that fits through the closable openings. There can also be one or more sensors configured to monitor the presence of material on the filter, and a controller configured to receive information from the sensors indicating the presence of material on the filter and to actuate the filter to open or close the closable openings in response to the information from the sensors.

Further embodiments of the present disclosure are directed to a method of filtering material from a fluid flow. The method includes depositing the fluid flow onto a raised portion of a filter, the filter having sloped sides configured to direct the fluid flow at least approximately equally in two or more lateral directions, and actuating the openings in the filter to accommodate a predetermined size of material to filter out the material from the fluid flow. The method also includes collecting the material separate from the filtered fluid.

### BRIEF DESCRIPTION OF THE FIGURES

FIG. 1 is an illustration of a conventional possum belly according to the prior art.

FIG. 2 is an illustration of an integrated possum belly according to embodiments of the present disclosure.

FIG. 3 is a cross-sectional view of the possum belly of FIG. 2 according to embodiments of the present disclosure.

FIG. 4 is a top-down view of a possum belly according to embodiments of the present disclosure.

FIGS. 5a and 5b are side and top views, respectively, of a possum belly according to embodiments of the present disclosure.

### DETAILED DESCRIPTION

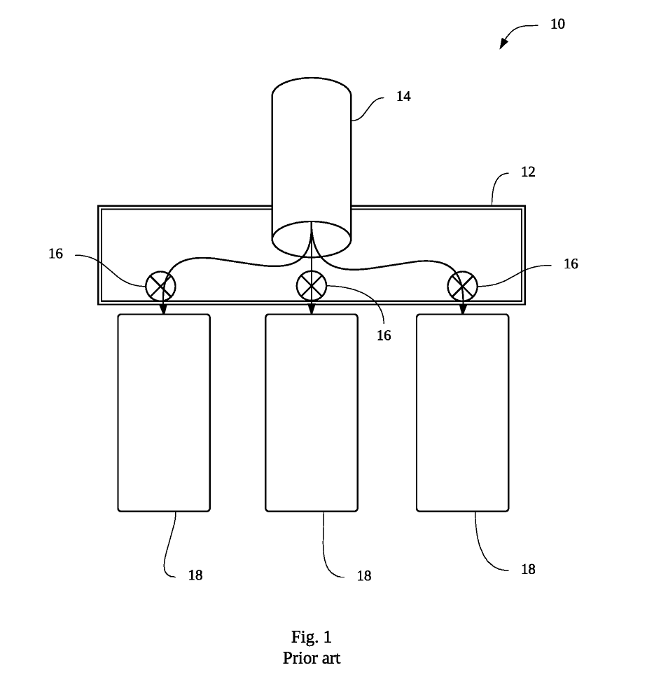

Below is a detailed description according to various embodiments of the present disclosure. FIG. 1 is an illustration of a conventional possum belly 10 according to the prior art. The possum belly 10 includes a tray 12 that receives a flow of fluid from a tube 14. The tube 14 dumps the fluid into the tray 12. The tray has valves 16 which allow the fluid to pass into shakers 18 which shake the fluid to separate the good drilling mud from cuttings and other debris. The configuration of the tray 12, valves 16, and shakers 18 can cause an inefficient distribution of fluid with most going through the central valve and to the central shaker. When gumbo formations are created, these lines can easily clog and sometimes require expensive and manually-intensive intervention to clear.

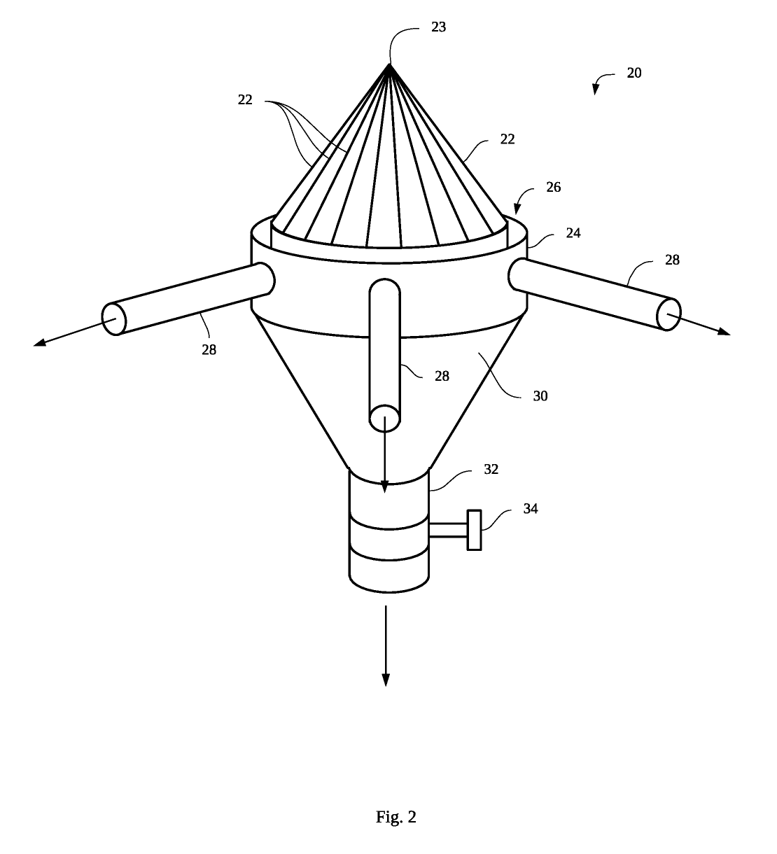

FIG. 2 is an illustration of an integrated possum belly 20 according to embodiments of the present disclosure. The possum belly includes a cone 22 and a drum 24. The cone 22 has an apex 23 and is constructed of a plurality of slats 25. The cone 22 is positioned inside the drum 24 with a space 26 formed between the cone 22 and the drum 24. The cone 22 is a filter. The slats 25 are spaced such that drilling fluid can flow between the slats 25 and cuttings, debris, and gumbo cannot. The slats 25 can be selectively opened or closed to permit different quantities of fluid to pass through the cone 22. In operation a drilling fluid is directed downwardly onto the cone 22 and gumbo falls into the space 26 between the cone 22 and the drum 24 and good drilling fluid falls through the slats 25 and is collected. The slats 25 of the cone 22 can form a first layer, and the cone 22 can have a second layer of slats (not pictured) just beneath the slats 25. The first and second layer can rotate relative to one another to open or close the cone 22. In some embodiments, the second layer rotates while the first layer is fixed. In other embodiments the first layer rotates while the second layer is fixed. In other embodiments both the first and second layers rotate relative to the drum 24. The slats 25 of the first layer and the slats of the second layer can rotate by approximately the width of a single slat such that there are two rotational positions of the layers: a first position in which the slats are completely closed, and a second position in which the slats are overlapping and the spaces between slats of the first layer and the second layer are aligned resulting in a maximum opening. In this configuration the cone 22 allows the largest particles to pass through the cone 22. The rotational position of the layers relative to one another determines the size of particles that can pass through. An operator can choose how much to open the slats according to the needs of a given situation. Larger gumbo will result in a larger opening position.

In some embodiments the slats of the first and second layer have the same width and the same number of slats. As such, the layers can be rotated relative to one another (with one or the other or neither being fixed) between a fully open position in which the slats overlap and a fully closed position in which the slats of the second layer bridge the spaces between slats of the first layer. Other configurations are possible as well including having slats of different sizes in the first layer and the second layer. For example, the slats and spaces of the first layer can be larger than the slats and spaces of the second layer. In this formation, the slats of the second layer are not large enough to fully close the cone 22, but in a fully open position with the slats of the second layer smaller than and covered by the slats of the first layer, the cone 22 may perhaps be able to withstand a higher fluid flow rate by covering the slats of the second layer. In still further embodiments the slats and spaces of either the first or second layer can be irregular. The layers can rotate relative to one another more than a single slat width, and in some cases can include a fully 360 degree rotation of the layers. The irregularity of the slats and spaces and the full rotational capability of this configuration allows for more precise customization of the size and orientation of the spaces.

The possum belly 20 also includes a plurality of conduits 28 which are coupled to the cone 22 and are configured to receive fluid passing through the cone 22. The drum 24 has a lower portion 30 which can be tapered to conduct the received drilling fluid. There is a lower pipe 32 and a valve 34 which operate to conduct the drilling fluid away from the possum belly 20 for reintroduction into a drilling operation or for other processing.

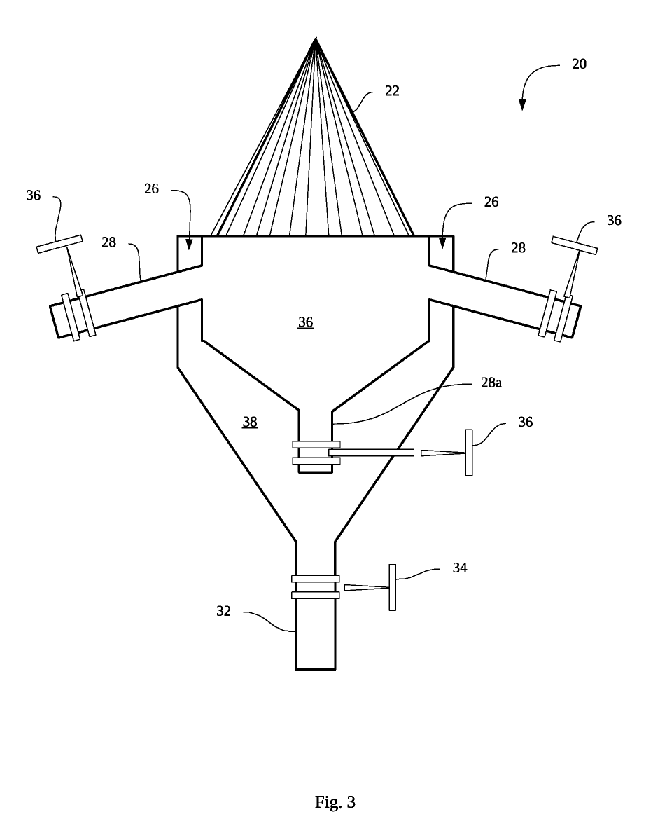

FIG. 3 is a cross-sectional view of the possum belly 20 of FIG. 2 according to embodiments of the present disclosure. Interior features of the possum belly 20 are shown in FIG. 3. The interior shape of the drum 24 can include a chamber 36 that is positioned inside the drum 24 leaving the space 26 between the exterior of the drum 24 and the chamber 36. The gumbo and other material that does not fit through the cone 22 passes downward into the space 26 and into a secondary, lower chamber 38 which is drained through the lower pipe 32. The conduits 28 are coupled to other pipes that are not shown in these figures. The pipes can recirculate the drilling fluid that passes through the cone 22. The central conduit 28a shown in FIG. 3 extends outward toward the viewer and is coupled to another pipe and does not feed downward into the lower pipe 32. A plurality of valves 36 can be positioned in the conduits 28 to allow selective opening, closing, or throttling of the flow of fluid through the conduits. Valve 34 operates similarly for the lower pipe 32.

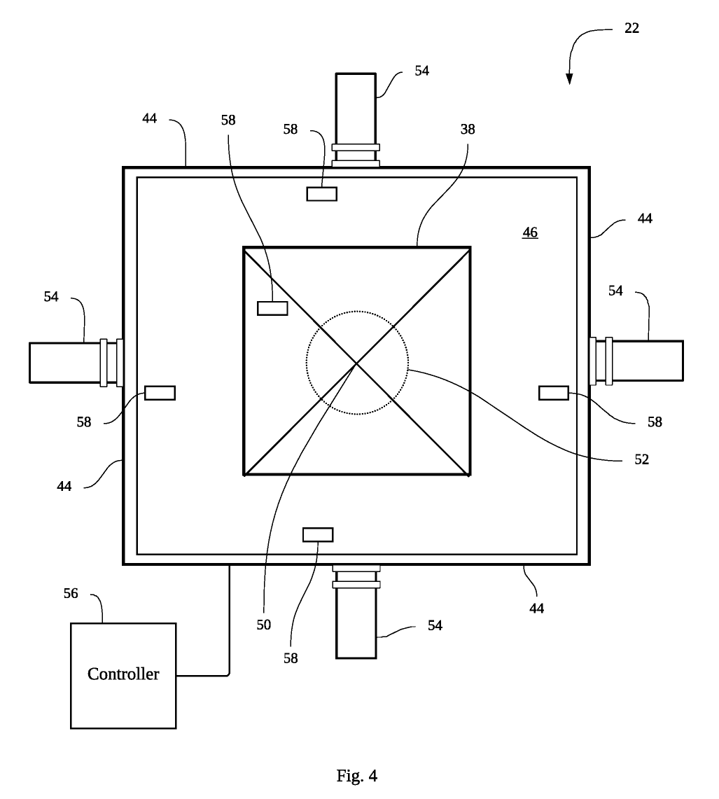

FIG. 4 is a top-down view of a possum belly 40 according to embodiments of the present disclosure. The possum belly 40 includes a tray 42 with side walls 44 and a trough area 46. The possum belly 40 also includes a pyramid filter 48 that protrudes upward toward the viewer and has four sides and an apex 50. A dotted circle 52 represents a pipe from which material is deposited onto the pyramid filter 48 from above. Below the pyramid filter 48 and the trough area 46 is a lower collection area that collects fluid passing through the pyramid filter 48. This material can be recirculated into a drilling fluid circuit or otherwise handled. The pyramid filter 48 can operate in a similar manner to the cone 22 shown in FIGS. 2 and 3. The sides of the pyramid filter 48 can have openings that can be opened or closed to permit fluid to pass through the pyramid filter 48 while preventing gumbo from passing through the pyramid filter 48. The openings can be formed from slats in multiple layers as described above with reference to the cone 22, or the openings can be actuated in a different way. The openings can be in the form of a sliding door-like feature that moves along the surface of the side to open or close the pyramid filter 48. The symmetrical nature of the pyramid filter 48 allows for more efficient handling of drilling fluid and removal of gumbo. With the delivery pipe positioned over the apex 50, the fluid will fall in equal quantities on each of the four sides of the pyramid filter 48. In some embodiments the pyramid filter 48 can have more than four sides and indeed can include virtually any number of sides. Drilling fluid that passes through the pyramid filter 48 falls downward into a collection chamber similar to what is shown and described with respect to FIGS. 2 and 3. Gumbo and other detritus that does not fit is collected in the tray 42.

The tray 42 has a plurality of ports 54 which can be selectively opened or closed to permit the material and fluid in the tray 42 to be disposed of. The ports 54 can be connected to conduits or other delivery or collection means including shakers. The ports 54 and the openings in the pyramid filter 48 can be integrated with a controller 56 which can be configured to operate the ports 54 and the pyramid filter 48. The possum belly 40 can also include a plurality of sensors 58 positioned around the tray 42, in the trough portion 46, on the pyramid filter 48, and in other suitable positions on the possum belly 40. The sensors and the controller can work together to operate the possum belly in an automated fashion. The sensors 58 can determine if there is gumbo in the flow. If there is no gumbo, the pyramid filter 48 can open fully to allow the drilling fluid to move through the pyramid filter 48 as quickly as possible. If there is gumbo, the sensors 58 can detect it and the controller 56 can actuate the pyramid grate 48 to open fully or partially according to the size of the gumbo or other debris in the flow. There can be sensors below the pyramid filter 48 which are in the clean portion of the flow. If these sensors detect that gumbo or some other unwanted material is in this flow, the controller 56 can close the pyramid filter 48 further and can issue a warning to alert an operator to the situation. The ports 54 can also be opened to varying degrees to allow material of greater or lesser size to pass through as the case may require. The sensors 58 can also detect if the gumbo or other unwanted material in the tray 42 is collecting in an uneven fashion with more at one port and less at another. The ports 54 can be opened or closed to even out the fluid.

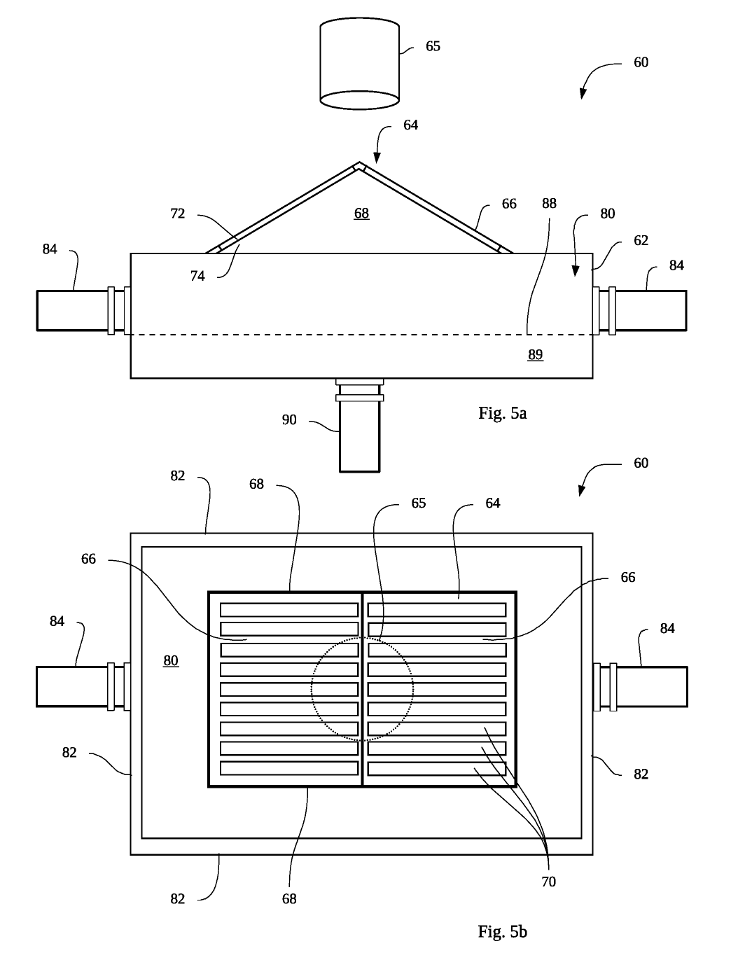

FIGS. 5a and 5b are side and top views, respectively, of a possum belly 60 according to embodiments of the present disclosure. Referring simultaneously to FIGS. 5a and 5b, the possum belly 60 includes a tray 62 and filter 64. The filter 62 has two sloped sides 66 and two vertical sides 68. A fluid delivery pipe 65 is positioned above the filter 64 and is shown in a dotted circle in FIG. 5b. In some embodiments the sloped sides 66 have a plurality of slats 70 on an upwardly-facing surface forming a first layer 72 and a second layer 74 below the first layer 72 with a corresponding series of slats and spaces. Moving the second layer 74 relative to the first layer 72 opens or closes the filter 64 by aligning or misaligning the spaces in the first layer 72 and the second layer 74. In some embodiments, either the first layer 72, the second layer 74, or both layers can move relative to one another. The layers can be moved by an actuator such as a mechanical, electrical, hydraulic, magnetic, or another suitable actuator.

The filter 64 can be positioned in a fully open position with the spaces in the first and second layers being aligned, a fully closed position in which slats 70 of the first layer 72 are aligned with spaces in the second layer 74, or any intermediate position where the slats 70 of the first layer are partially aligned with spaces of the second layer 74. There can be discrete positions such as 0%, 25%, 50%, 75%, and 100% open, or another suitable selection of positions between open and closed. The further open the filter 64 is, the larger particle, debris, or gumbo is permitted to pass through the filter 64. The tray 82 includes a trough portion 80, side walls 82, a lower collection area 89, and a plurality of ports 84. The tray 82 operates in a manner generally analogous to the tray 42 shown in FIG. 4 and described above. The lower collection area 89 is separated from the trough portion 80 by a floor 88 shown in phantom lines in FIG. 5a. A lower port 90 drains material from the lower collection area. The filter 62 permits some fluid to pass through the filter 62 and into the lower collection area 89, while material that does not pass through the filter remains in the trough portion 80.

The configuration of the present disclosure allows for an even distribution of fluid throughout the possum belly 60, without clogging one port earlier than another. It is to be appreciated that the filter 62 can have more sides and that the angle of the sloped sides 66 can vary as needed for a particular application. There can be a varying number of ports 84 to deliver the material collected to various destinations. The possum belly configurations shown and described in the present disclosure have been described with respect to drilling fluid and using primarily gumbo and other debris as the unwanted material to be filtered out; however, it is to be appreciated that the apparatuses and techniques of the present disclosure can be used with any other fluid to be filtered or otherwise treated.

Opening and closing of the filter 62 and the ports 84 can be controlled by a controller (not pictured) that is electrically coupled to these components. Sensors can be deployed throughout the possum belly 60 and can be used to deliver information relating to the status of the possum belly 60. If there is a need to open or close the filter 62 or the ports 84, 90, the controller can receive this information from the sensors and can execute some logic to actuate the filter 62 or the ports 84, 90. In some embodiments these systems are integrated together such that the possum belly 60 can operate with minimal intervention, eliminating the need for an operator to manually clear gumbo, and preventing clogs which prevents system downtime.

1. An apparatus, comprising:
a filter having a plurality of slats forming an apex and sloped sides, the slats forming a first layer;
a second layer being movable relative to the first layer from a first position to a second position, wherein in the first position the slats are aligned with openings in the second layer and the filter is closed, and wherein in the second position the openings in the second layer are positioned at least partially between the slats and the filter is at least partially open;
a trough positioned relative to the filter to receive material deposited onto the filter from above that does not pass through the filter; and
a lower collection area below the filter and being configured to receive material deposited onto the filter from above that passes through the filter.

2. The apparatus of claim 1 wherein the slats form a cone-shaped filter and wherein the second layer is rotatable relative to the first layer.

3. The apparatus of claim 1 wherein the slats form a pyramid and wherein the second layer moves linearly relative to the first layer.

4. The apparatus of claim 1 wherein the slats form two or more flat sloped surfaces and wherein the apex is linear and is formed at an intersection of two or more of the flat sloped surfaces.

5. The apparatus of claim 4 wherein the second layer moves linearly relative to the first layer.

6. The apparatus of claim 1, further comprising a plurality of sensors configured to detect the presence or absence of material above the filter.

7. The apparatus of claim 6, further comprising a controller being operably coupled to the sensors and to the filter, the controller being configured to receive information from the sensors and to actuate the second layer to open or close the filter in response to the information received from the sensors.

8. The apparatus of claim 1 wherein the filter is configured to filter gumbo formations from a drilling mud fluid.

9. The apparatus of claim 8 wherein the lower collection area is configured to deliver fluid to a shaker for further processing of the drilling mud fluid.

10. The apparatus of claim 1, further comprising a fluid delivery pipe positioned above the apex and being configured to deliver the material onto the filter at the apex.

11. An integrated possum belly, comprising:
a filter unit having sloped sides, an apex, and a plurality of closable openings, the filter being configured to receive a fluid deposited onto the apex from above;
a first receiving chamber configured to receive material that does not fit through the closable openings;
a second receiving chamber configured to receive material that fits through the closable openings;
one or more sensors configured to monitor the presence of material on the filter; and
a controller configured to receive information from the sensors indicating the presence of material on the filter and to actuate the filter to open or close the closable openings in response to the information from the sensors.

12. The integrated possum belly of claim 11 wherein the material is a drilling mud, the integrated possum belly further comprising one or more shakers configured to receive the material that fits through the closable openings.

13. The integrated possum belly of claim 11 wherein the filter unit has a cone shape formed by the sloped sides.

14. The integrated possum belly of claim 13 wherein the closable openings are movable between an open position and a closed position by rotating at least part of the filter unit.

15. The integrated possum belly of claim 11 wherein the sloped sides are flat and the closable openings are formed by a first layer of slats and a second layer of slats, wherein the closable openings comprise the spaces between the slats.

16. The integrated possum belly of claim 15 wherein the sloped sides form a pyramid shape and the apex is a point.

17. The integrated possum belly of claim 15 wherein the apex is a linear portion of the filter.

18. A method of filtering material from a fluid flow, the method comprising:
depositing the fluid flow onto a raised portion of a filter, the filter having sloped sides configured to direct the fluid flow at least approximately equally in two or more lateral directions;
actuating the openings in the filter to accommodate a predetermined size of material to filter out the material from the fluid flow; and
collecting the material separate from the filtered fluid.

19. The method of claim 18, further comprising monitoring a presence or absence of the material on the filter and actuating the openings in response to the presence or absence of the material.

20. The method of claim 18 wherein the fluid flow is a drilling fluid and the material is gumbo to be filtered out of the fluid flow.
